(19) United States
(12) Patent Application Publication
(10) Pub. No.: US 2012/0113561 A1
(43) Pub. Date: May 10, 2012

(54) CAPACITOR DEVICE AND METHOD FOR FORMING THE SAME

(75) Inventor: Albert Chin, Hsinchu City (TW)

(73) Assignee: NATIONAL CHIAO TUNG UNIVERSITY, Hsinchu City (TW)

(21) Appl. No.: 12/939,222

(22) Filed: Nov. 4, 2010

(51) Int. Cl. H01G 4/06; B23K 26/00

(52) U.S. Cl. 361/311; 219/121.85

(57) ABSTRACT

The present invention related to a method for forming a capacitor device, comprising steps of: providing a substrate, forming a first metal layer on the substrate, forming a dielectric on the first metal layer, applying a laser-annealing to the dielectric, and forming a second metal layer on the dielectric.

### FIELD OF THE INVENTION

The present invention relates to capacitors, and more particularly to High-κ MIM Capacitors.

### BACKGROUND OF THE INVENTION

Metal-Insulator-Metal (MIM) capacitors are widely used for analog module, RF and DRAM functions in ICs. Higher relative permittivity (or higher dielectric coefficient κ) dielectrics have been used for MIM capacitors to reach higher capacitance density (ε₀κ/t_{D}) with low leakage current. However, the conduction band offset (ΔE_{C}) of metal-oxides generally decreases rapidly with increasing κ value. The small ΔE_{C} of SrTiO₃ (STO) has significant impact to degrade analog capacitor reliability and leakage current. Besides, the physical thickness of the high-κ insulator should be scaled down to fit the minimum feature size that limits the use of very high κ material. Therefore, using new higher-κ dielectric materials may not be a feasible option.

Therefore the applicant attempts to deal with the above situation encountered in the prior art.

### SUMMARY OF THE INVENTION

In view of the prior art, in the present invention, we propose an alternative method to enhance permittivity through the laser annealing technique (conventionally used in ultra-shallow junction formation) which initiates a microstructural polycrystalline tetragonal-phase change in the dielectric (preferably ZrO₂) thereby the κ value is enhanced. The new process sequence helps enhancing the capacitance density, for example, from 38 to 52 fF/μm² with low leakage and good 10-year reliability.

In accordance with the first aspect of the present invention, a method for forming a capacitor device is provided. The method includes steps of: providing a substrate; forming a first metal layer on the substrate; forming a dielectric on the first metal layer; applying a laser-annealing to the dielectric; and forming a second metal layer on the dielectric.

Preferably, the substrate is an SiO₂/Si substrate.

Preferably, the first metal layer is a bottom electrode of the capacitor device, is one selected from a group consisting of TaN, TiN, Al, Ni, Ir Pt, Ru and RuO₂ and is deposited and patterned on the substrate.

Preferably, the first metal layer has a first surface, and the step of forming a first metal layer on the substrate further comprises a step of treating the first surface by NH₃⁺ plasma.

Preferably, the dielectric is one selected from a group consisting of ZrO₂, Al₂O₃, HfO₂, TiO₂, La₂O₃, LaAlO and SrTiO₃.

Preferably, the step of forming a dielectric on the first metal layer further comprises a step of depositing the dielectric by an Atomic Layer Deposition (ALD).

Preferably, the method further includes a step, before forming a dielectric on the first metal layer, of applying an O₂ post-deposition annealing (PDA) to the dielectric.

Preferably, the second metal layer on the dielectric is a top electrode of the capacitor device and is a high work-function metal.

Preferably, the second metal layer on the dielectric is a top electrode of the capacitor device and is one selected from a group consisting of Ni, TiN, Pt, Ir, Ru and RuO₂.

In accordance with the second aspect of the present invention, a capacitor device is provided. The capacitor device includes: a dielectric having a tetragonal phase.

Preferably, the dielectric is processed by a laser annealing.

Preferably, the capacitor device further includes: a substrate; a first metal layer formed on the substrate and forming thereon the dielectric; and a second metal layer formed on the dielectric.

Preferably, the substrate is an SiO₂/Si substrate.

Preferably, the first metal layer is a bottom electrode of the capacitor device, is one selected from a group consisting of TaN, TiN, Al, Ni, Ir and Pt, Ru, RuO₂ and is deposited and patterned on the substrate.

Preferably, the first metal layer has a first surface treated by NH₃⁺ plasma.

Preferably, the second metal layer on the dielectric is a top electrode of the capacitor device and is a high work-function metal.

Preferably, the second metal layer on the dielectric is a top electrode of the capacitor device and is one selected from a group consisting of Ni, TiN, Pt, Ir, Ru, RuO₂.

Preferably, the dielectric is one selected from a group consisting of ZrO₂, Al₂O₃, HfO₂, TiO₂, La₂O₃, LaAlO and SrTiO₃.

Preferably, the dielectric is deposited by an Atomic Layer Deposition (ALD).

In accordance with the third aspect of the present invention, a method for forming a capacitor device with a dielectric is provided. The method includes a step of: processing the dielectric to have a tetragonal phase.

### BRIEF DESCRIPTION OF THE DRAWINGS

The foregoing and other features and advantages of the present invention will be more clearly understood through the following descriptions with reference to the drawings, wherein:

FIG. 1 is a fabrication flow of an MIM capacitor;

FIG. 2 is a cross section of an MIM capacitor;

FIG. 3 illustrates the C-V and J-V characteristics of the Ni/ZrO₂/TiN MIM capacitors using laser annealing under various power densities;

FIG. 4 illustrates XRD spectra of the Ni/ZrO₂/TiN capacitors (a) before and (b) after laser annealing;

FIG. 5 illustrates cross-sectional TEM of the Ni/ZrO₂/TiN capacitors (a) before and (b) after laser annealing; and

FIG. 6 illustrates C/C as a function of stress time for extrapolated 10 years span of the Ni/ZrO₂/TiN capacitors before and after laser annealing.

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

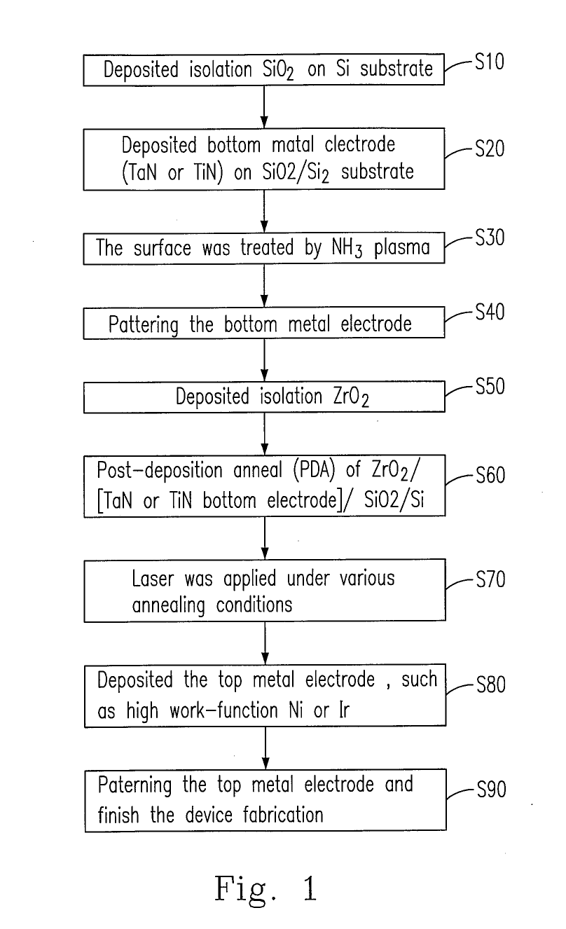

Please refer to FIG. 1, which is a fabrication flow of an MIM, preferably Ni/ZrO₂/TiN, capacitor for illustrating an embodiment according to the present invention. As shown in FIG. 1, the MIM capacitor was made on a substrate, preferably an SiO₂/Si substrate, for VLSI backend integration (S10). TiN was first deposited and patterned to form the bottom electrode (S20).

Then the surface was treated by NH₃⁺ (S30) to prevent capacitance-equivalent-thickness (CET) degradation by forming interfacial TiON during post-deposition anneal (PDA). After that, 8 nm ZrO₂ was formed by Atomic Layer Deposition (ALD) and an O₂ PDA at 400° C. was used to improve the dielectric quality (S40˜S60). Then laser, preferably continuous wave (CW) laser such as Ar⁺ laser at 157 nm˜514.5 nm wavelength or pulsed excimer laser such as KrF and ArF laser, was applied under various annealing conditions (S70). Finally, the high work-function and low-cost Ni of 50 nm was deposited and patterned to form the top electrode (S80˜S90).

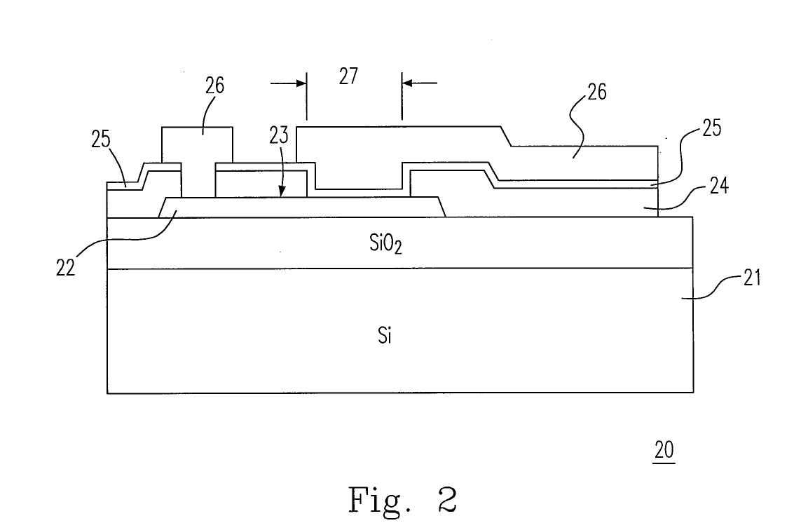

FIG. 2 is a cross section of an MIM capacitor 20 corresponding to the above-mentioned fabrication flow in FIG. 1. The MIM capacitor includes a substrate 21, a first electrode 22 (preferably a bottom electrode), NH3⁺ plasma nitridation layer 23, isolation oxide 24, a dielectric 25 (preferably ZrO₂), a second electrode (preferably a top electrode) 26, and an active area 27. The substrate 21 is preferably an SiO₂/Si substrate. The first electrode 22 is formed on the substrate 21, and preferably is one selected from a group consisting of TaN, TiN, Al, Ni, Ir ,Ru, RuO₂ and Pt. The dielectric 25 is one selected from a group consisting of ZrO₂, Al₂O₃, HfO₂, TiO₂, La₂O₃, LaAlO and SrTiO₃. In addition, the permittivity of the dielectric 25 is improved due to tetragonal-phase formation during a laser annealing. The second electrode 26 is formed on the dielectric 26, which is preferably a high work-function metal and is one selected from a group consisting of Ni, TiN, Pt, Ir, Ru, RuO₂.

The capacitor size is 100-μm×100-μm. The crystallinity of the second electrode/dielectric/first electrode, preferably Ni/ZrO₂/TiN, structure was examined using the X-ray diffraction (XRD) tool. The MIM device was characterized by C-V and J-V measurements.

It is important to notice that the surface nitridation is necessary to reach high capacitance density after laser annealing. The capacitance density will decrease without the surface nitridation treatment due to the oxidation of bottom electrode.

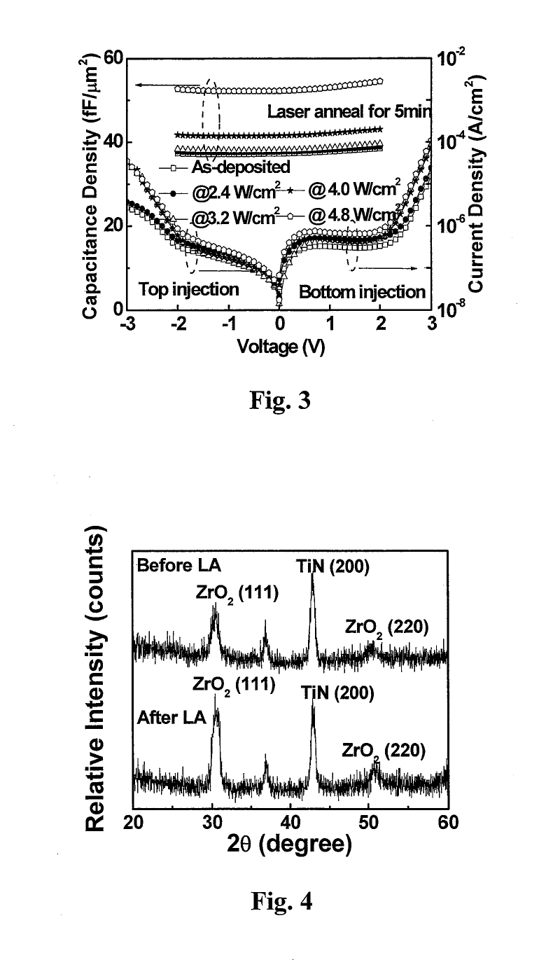

FIG. 3 shows the C-V and J-V characteristics of Ni/ZrO₂/TiN MIM capacitors before and after laser annealing. The merits of using Ni electrode are the reactive ion etching (RIE) friendly process and much lower leakage current than TiN due to its higher work-function of 5.1 eV. For a constant laser annealing time, the capacitance density increases monotonically with increasing laser power density. Similarly, an increase in capacitance density with laser annealing time is also observed. These results indicate that the improved capacitance density is related to laser energy. Although the leakage current increases slightly with increasing laser energy, low leakage current of 2.5×10⁻⁷ A/cm² at −1 V is still reached with a very high capacitance density of 52 fF/μm², a higher κ of 45 and a CET of 0.66 nm. These results are much better than the control devices before laser annealing, with a capacitance density of 37 fF/μm² and a leakage current 1.4×10⁻⁷ A/cm² at −1 V. The slightly increased leakage current after laser annealing is related to the larger polycrystalline ZrO₂ dielectric found in cross-sectional TEM.

To understand the performance improvements, we have examined the devices by XRD. The anneal improves the ZrO₂ crystallinity of higher-κ tetragonal-phase by showing stronger XRD peaks, compared with the reference TiN, as shown in FIG. 4. Therefore, the higher capacitance density after laser annealing is related to the better crystallinity (preferably (111) orientation) and higher κ value (preferably higher than 35) of ZrO₂. It is important to notice that the reached κ of 45 is only slightly lower than the theoretical calculation of tetragonal-phase ZrO₂. Therefore, laser annealing can initiate a microstructural polycrystalline tetragonal-phase formation in the ZrO₂ that is affirmed by XRD measurements. Although similar higher κ is also reported in HfO₂ by Rapid Thermal Anneal (RTA), the laser annealing gives a significant larger improvement. This may be due to the focused energy absorption within ZrO₂/TiN structure by laser annealing.

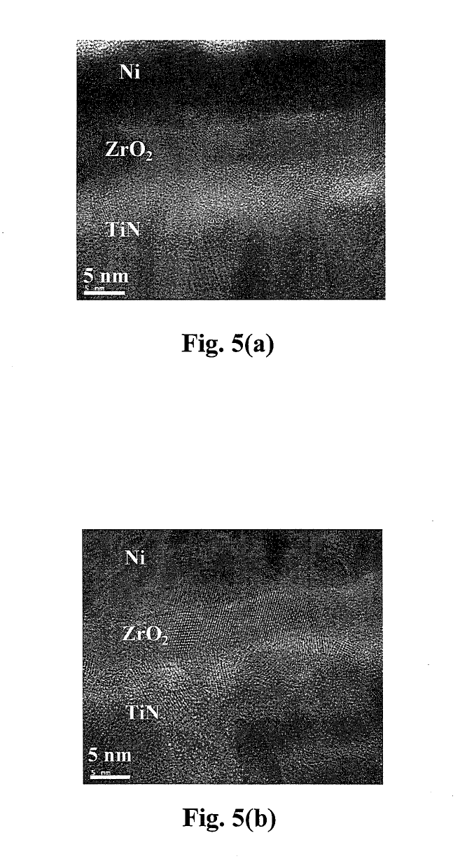

We used the TEM to study the laser annealing effect. FIGS. 5(a) and 5(b) further show cross-sectional TEM of Ni/ZrO₂/TiN capacitors before and after laser annealing. Clear better crystallization of ZrO₂ is observed after laser annealing, which is consistent with the stronger XRD signal of ZrO₂. From the measured capacitance density and thickness, a κ value of 31 was obtained for as-deposited ZrO₂ that increases to 45 after increasing laser power density to 4.8 W/cm² for 5 min annealing. The capacitance density and κ value increase by ˜40% after laser annealing.

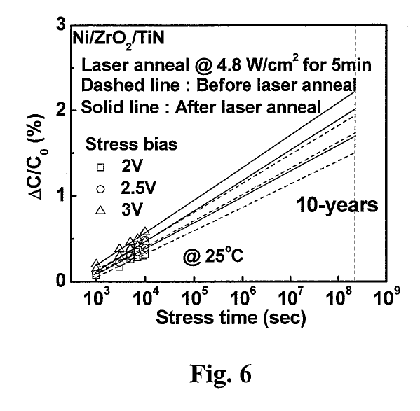

An important reliability criterion in the industry is the expected degradation of device performance for a 10-year target lifespan. FIG. 6 shows the ΔC/C as a function of time at 25° C. after constant voltage stress. Here the room temperature stress is used, since the ΔC/C is worse at room temperature than 125° C. in this experiment. This is because the trapped electrons can be released by larger thermal energy at higher temperature. Good 10-year reliability with a small ΔC/C of 1.7% at 2 V is obtained for Ni/ZrO₂/TiN capacitor operation with a very high 52 fF/μm² capacitance density.

We have fabricated high-κ Ni/ZrO₂/TiN metal-insulator-metal (MIM) capacitors with a very high 52 fF/μm² capacitance density, a low leakage current of 1.6×10⁻⁷ A/cm² and good 10-year reliability with a small ΔC/C of 1.7% at 2 V. From x-ray diffraction measurements, laser annealing can improve the permittivity of ZrO₂ due to tetragonal-phase formation which in turn helps enhance capacitance density and reliability. Such excellent device integrity is attributed to the combination of enhanced ZrO₂ tetragonal-phase by laser annealing, high work-function Ni electrode and good bottom-interface treatment.

In the present application, high performance Ni/ZrO₂/TiN device is realized with higher capacitance density, low leakage current, good analog capacitor reliability, low cost electrodes, smaller CET and physical oxide thickness using laser annealing. This provides an alternative technology to attain higher κ dielectric for future generation devices without continuously changing to new materials.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for forming a capacitor device, comprising steps of:
providing a substrate;
forming a first metal layer on the substrate;
forming a dielectric on the first metal layer;
applying a laser-annealing to the dielectric; and
forming a second metal layer on the dielectric.

2. The method as claimed in claim 1, wherein the substrate is a SiO₂/Si substrate.

3. The method as claimed in claim 1, wherein the first metal layer is a bottom electrode of the capacitor device, is one selected from a group consisting of TaN, TiN, Al, Ni, Ir, Ru, RuO₂ and Pt, and is deposited and patterned on the substrate.

4. The method as claimed in claim 1, wherein the first metal layer has a first surface, and the step of forming a first metal layer on the substrate further comprises a step of treating the first surface by NH₃⁺ plasma.

5. The method as claimed in claim 1, wherein the dielectric is one selected from a group consisting of ZrO₂, Al₂O₃, HfO₂, TiO₂, La₂O₃, LaAlO and SrTiO₃.

6. The method as claimed in claim 1, wherein the step of forming a dielectric on the first metal layer further comprises a step of depositing the dielectric by an Atomic Layer Deposition (ALD).

7. The method as claimed in claim 1, further comprising a step, before forming a dielectric on the first metal layer, of applying an O₂ post-deposition annealing (PDA) to the dielectric.

8. The method as claimed in claim 1, wherein the second metal layer on the dielectric is a top electrode of the capacitor device and is a high work-function metal.

9. The method as claimed in claim 1, wherein the second metal layer on the dielectric is a top electrode of the capacitor device and is one selected from a group consisting of Ni, TiN, Pt, Ir, Ru, RuO₂.

10. A capacitor device, comprising:
a dielectric processed by a laser annealing.

11. The capacitor device as claimed in claim 10, wherein the dielectric has a tetragonal phase, and the laser annealing is performed by one of continuous wave (CW) laser and pulsed excimer laser.

12. The capacitor device as claimed in claim 10, further comprising:
a substrate;
a first metal layer formed on the substrate and forming thereon the dielectric; and
a second metal layer formed on the dielectric.

13. The capacitor device as claimed in claim 11, wherein the substrate is an SiO₂/Si substrate.

14. The capacitor device as claimed in claim 11, wherein the first metal layer is a bottom electrode of the capacitor device, is one selected from a group consisting of TaN, TiN, Al, Ni, Ir, Ru, RuO₂ and Pt, and is deposited and patterned on the substrate.

15. The capacitor device as claimed in claim 11, wherein the first metal layer has a first surface treated by NH₃⁺ plasma.

16. The capacitor device as claimed in claim 11, wherein the second metal layer on the dielectric is a top electrode of the capacitor device and is a high work-function metal.

17. The capacitor device as claimed in claim 11, wherein the second metal layer on the dielectric is a top electrode of the capacitor device and is one selected from a group consisting of Ni, TiN, Pt, Ir, Ru, RuO₂.

18. The capacitor device as claimed in claim 10, wherein the dielectric is one selected from a group consisting of ZrO₂, Al₂O₃, HfO₂, TiO₂, La₂O₃, LaAlO and SrTiO₃.

19. The capacitor device as claimed in claim 10, wherein the dielectric is deposited by an Atomic Layer Deposition (ALD).

20. A method for forming a capacitor device with a dielectric, comprising a step of:
Laser annealing processing the dielectric to have a (111) orientation, a dielectric constant higher than 35, a tetragonal phase, or a combination thereof.
